(19) United States
(12) Patent Application Publication
(10) Pub. No.: US 2026/0180884 A1
(43) Pub. Date: Jun. 25, 2026

(54) NETWORK PERFORMANCE MANAGEMENT ENGINE

(71) Applicant: eBay Inc., San Jose, CA (US)

(72) Inventors: Cheng XU, British Columbia (CA); Wenli XIE, Cupertino, CA (US); Sharad R. MURTHY, San Ramon, CA (US)

(21) Appl. No.: 18/988,552

(22) Filed: Dec. 19, 2024

(51) Int. Cl. H04L 43/0864; H04L 43/50; H04L 47/125

(52) U.S. Cl. CPC H04L 43/0864; H04L 43/50; H04L 47/125

(57) ABSTRACT

Methods, systems, and computer storage media for providing a network management engine in a cloud computing system are described. Network management engine is an end-to-end system that oversees, monitors, and optimizes the full lifecycle of network traffic, from the initial client request to the final data response. By capturing, analyzing, and managing network packets, it ensures seamless data flow and tracks key performance metrics to identify and resolve latency or congestion issues. Network management engine supports monitoring, and fault detection for efficient data flow, capturing metrics, and analyzing performance. Network management engine includes network packet management extension engine and network performance management engine. Network packet management extension engine is a specialized engine designed for calculating and analyzing packet latency at various stages of a network path. Network performance management engine is a specialized engine that identifies and manages deviations from expected network behavior, particularly in areas where latency may occur.

### BACKGROUND

Users can interact with a cloud mesh network in different types of applications and services to accomplish network tasks. A cloud mesh network refers to a distributed, interconnected system of multiple cloud environments that work together to provide scalable, flexible, and resilient network services across diverse geographical locations. A cloud mesh network enables seamless communication and data sharing between various cloud platforms, allowing users to optimize resource allocation, improve data transfer speeds, and enhance fault tolerance. By utilizing a mesh architecture, cloud resources can dynamically interconnect, ensuring high availability and redundancy. This type of network can support applications and services in various domains, such as load balancing, disaster recovery, and global content delivery. Through advanced routing protocols and automated resource management, a cloud mesh network enhances the overall performance and reliability of cloud-based systems, making it an ideal solution for enterprises and service providers with complex, distributed infrastructure needs.

### SUMMARY

Various aspects of the technology described herein are generally directed to systems, methods, and computer storage media for, among other things, providing a network management engine in a cloud computing system. The network management engine is an end-to-end system that oversees, monitors, and optimizes the full lifecycle of network traffic, from the initial client request to the final data response. By capturing, analyzing, and managing network packets, it ensures seamless data flow and tracks key performance metrics to identify and resolve latency or congestion issues. The network management engine leverages a layered approach to network management, monitoring, and fault detection to ensure efficient data flow, capturing metrics, and analyzing performance.

The network management engine includes a network packet management extension engine and a network performance management engine. The network packet management extension engine is a specialized engine designed for calculating and analyzing packet latency at various stages of a network path. The network packet management extension engine enhances network packet handling by capturing detailed information at crucial points in the flow. For instance, during client request processing and ingress at the Transport Layer Balancer (TLB) and data inspection and recording at Ingress Gateway (GW), the network packet management extension engine enables the measurement of packet transit times, captures metadata, and supports connection tracking by recording latency within the network. This network packet management extension engine powers custom processing and data recording that provides deep insight into latency dynamics across the network infrastructure.

The network performance management engine is a specialized engine that identifies and manages deviations from expected network behavior, particularly in areas where latency may occur. By monitoring network traffic, analyzing latency patterns, and visualizing data, the network performance management engine detects performance issues and supports automated remediation. Key features include latency calculation and graph generation at the client, which visualizes latency data through path analytics graphs, and automate analysis and remediation, which leverages tools to correlate latency with system resources and reroute traffic if necessary. The network performance management engine, through tools like the fault analyzer, provides a holistic view of network performance and aids in preemptive issue resolution.

Operationally, a client initiates requests to the application gateway, in order to receive responses that include network latency data captured via response headers. An Application Gateway (App GW) receives and validates incoming requests, which are then forwarded to a Transport Layer Balancer (TLB) based on established routing rules. The TLB distributes client requests across available backend resources, balancing the load. Packet interceptors (e.g., eBPF Extended Berkeley Packet Filter programs) are employed for timestamping, capturing ingress and egress times to monitor packet flow. A first packet interceptor adds an ingress timestamp to packets as the packets enter the TLB, while a second packet interceptor measures the egress time for packets leaving the TLB, computing the total processing duration within the TLB.

Packets are encapsulated by a tunnel for secure transport between the TLB and Ingress Gateway (GW). The Ingress GW routes traffic from the TLB to the appropriate backend services and works with a third packet interceptor to log packet traversal times, capturing relevant metadata for latency tracking. The third packet interceptor records ingress timestamps for packets arriving at the Ingress GW and monitors egress times for packets leaving, enabling detailed latency measurements.

An Application Gateway Envoy (App GW Envoy) operates to pass packets to backend servers and adds tracking headers with latency and node metadata for network visibility and end-to-end latency tracking—and then passes on annotated packets. Initially, a server processes client requests—received via a server envoy—by executing backend operations, routing responses back through the server envoy for header tracking. A server application processes clients requests based on business logic, generates responses, and sends them back through the server envoy. The App GW Envoy then adds final tracking headers to outgoing packets, completing the latency monitoring chain, and passes the packets to the client.

The client extracts and calculates the network latency data. The client can update a log (e.g., a log database) with path analytics graph to support generating alert. The log stores path analytics graphs generated at the client. A Time Series Database (TSDB) stores traffic metrics (e.g., latency and performance metrics over time) from the TLB and Ingress GW to support analysis (e.g., via a join with path analytics data) and enabling efficient data retrieval for fault analysis and trend visualization. A fault analyzer analyzes logs and time-series database data to identify network anomalies, generating fault alerts when deviations in network performance or latency are detected. These operations, centered on capturing, monitoring, and analyzing packet flow, are performed via the network management engine to provide end-to-end network performance management and fault detection.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram of a cloud mesh network architecture, in accordance with aspects of the technology described herein;

FIGS. 2A and 2B are block diagrams of a network management system for providing network management, in accordance with aspects of the technology described herein;

FIGS. 2C and 2D are block diagrams of a network management system for providing network management, in accordance with aspects of the technology described herein;

FIG. 3 is a block diagram of a network management system for providing network management, in accordance with aspects of the technology described herein;

FIG. 4A, AB, and 4C provide a first set of exemplary methods of providing network management in a network management system via a network packet management extension engine, in accordance with aspects of the technology described herein;

FIGS. 5A, 5B, and 5C provide a second set of exemplary methods of providing network management in a network management system via a network performance management engine, in accordance with aspects of the technology described herein

FIG. 6 provides a block diagram of an exemplary artificial intelligence system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION OF THE INVENTION

### Overview

A cloud computing system provides a distributed network of remote servers hosted on the internet to store, manage, and process data, rather than relying on local servers or personal computers. In the cloud computing system, resources such as storage, processing power, and applications are provided as a service to users over the internet. These services can be scaled according to demand and are often designed to support multi-tenant architectures, where multiple clients securely share the same infrastructure. The cloud computing system serves as the backbone for delivering seamless connectivity and distributed data processing, allowing client requests to be managed and processed across a network of interconnected resources.

A cloud mesh network provides a networking framework that enables seamless interconnection and communication between multiple cloud computing resources, often distributed across different physical and virtual environments. In a cloud mesh network, various nodes and gateways (such as application gateways, transport layer balancers, ingress gateways, and other network components) work together to create a unified network fabric that routes and balances traffic between distributed services. A cloud mesh network can be a tessellated mesh network (i.e., tess cloud mesh) might be used in geographically distributed sensor networks where the data points (or “nodes”) form a repeating, spatial pattern across a specific area. By establishing secure and efficient routing paths, a cloud mesh network allows data to flow between nodes with minimal latency, ensuring optimal performance and reliability.

In this way, the cloud computing system provides the underlying infrastructure to support distributed applications and storage, while the cloud mesh network manages the real-time flow of data between these distributed resources. Through this network, data is directed across various layers of processing (from client requests through load balancers and application gateways to backend services) with precise control over packet handling, timestamping, and latency tracking. Together, the cloud computing system and the cloud mesh network ensure that each request is processed efficiently, end-to-end latency is minimized, and anomalies in network behavior can be quickly detected and addressed through real-time monitoring and fault analysis.

Conventionally, network management systems are limited in providing detailed, real-time visibility into packet-level latency and traffic behavior, especially in complex and dynamic environments. This limitation makes it difficult for the system to accurately detect subtle anomalies, correlate them with specific network paths, and identify root causes in large, evolving network infrastructures. For instance, conventional network packet management systems are often limited in their ability to accurately calculate and quantify packet latency, especially in complex and dynamic network topologies. In such networks, packets may travel along different paths that are subject to varying levels of congestion, routing changes, or Quality of Service (QoS) configurations, all of which can introduce significant delays. For example, if a packet experiences congestion on one route, its latency may increase, while a packet taking an alternate route may encounter minimal delay.

These factors create a moving target for network management tools, making it difficult to provide precise visibility into the latency of every packet in real time. Although these tools can offer valuable insights into broad network performance trends, such as identifying general congestion points or large-scale latency issues, they often fall short of offering detailed, packet-level visibility required for precise troubleshooting. As a result, achieving accurate, real-time monitoring of packet latency in complex, changing environments remains a significant challenge. For example, a large enterprise network can have multiple redundant links between data centers. A network packet management system might report overall latency trends but fail to pinpoint whether a specific packet took a longer path due to a temporary routing change or congestion on one of the links. This lack of granularity makes it difficult for network administrators to understand the root cause of latency problems on a per-packet basis.

Similarly, traditional network performance management systems are limited in detecting anomalies and correlate them with specific node-level traffic metrics. Modern networks are inherently dynamic, with constantly changing traffic patterns, adaptive routing protocols, and varying QoS settings, all of which add layers of complexity. These dynamics make it challenging to maintain precise visibility into the behavior of network traffic at the packet level. For instance, if a particular link starts to experience higher-than-expected latency, it may take some time for the system to detect this anomaly, especially if the engine relies on sampled data or aggregated metrics, which may not capture the fine-grained details needed to identify subtle issues.

Moreover, a conventional performance management system that only monitors aggregated data from routers or switches might miss critical nuances, such as an intermittent spike in latency caused by an overloaded network node or an undetected network path failure. With limited visibility into specific network segments or paths, detecting such anomalies becomes even more difficult. In essence, without more advanced monitoring tools capable of providing deep packet-level insights and real-time correlation, identifying and addressing performance issues in complex, modern network infrastructures is a significant operational challenge. For example, a sudden drop in application performance due to latency might be incorrectly attributed to a wide-area network (WAN) bottleneck, when in reality, it could be the result of a temporary misconfiguration in the routing table of a specific network node. Without precise, per-packet visibility, such anomalies may go undetected, leading to delayed troubleshooting and resolution. As such, a more comprehensive network management system with an alternative basis for performing network management operations - can improve computing operations and interfaces for providing network management.

### DESCRIPTION OF TECHNICAL SOLUTION

At a high level, a network management engine in a cloud computing system oversees the entire lifecycle of network traffic, from client requests to data responses, by capturing, analyzing, and optimizing network packets to ensure seamless data flow. The network management engine includes two main components: a network packet management extension engine, which calculates and analyzes packet latency at key stages (such as during client request processing and data inspection), and a network performance management engine, which monitors traffic, detects latency deviations, visualizes data, and supports automated remediation to address performance issues and optimize network behavior.

A cloud computing network can be based on distributed cloud architecture (e.g., Cloud Mesh Network or Tess Cloud Mesh) that connects various services and resources in a mesh-like configuration, enhancing flexibility and scalability. In the context of cloud computing networks, it enables seamless communication and resource sharing between different components, allowing for dynamic load balancing, improved fault tolerance, and optimized resource utilization across multiple cloud environments.

By way of illustration, the distributed cloud architecture of a cloud computing network can be constituted of several Tess App Gateway (App GW) groups. Each App GW instance is made up of an Ingress GW and a TLB (Traffic Layer Balancer). The Ingress GW functions as a L7 load balancer, while the TLB serves as a L4 load balancer. L4 load balancers operate at the transport layer, directing traffic based on IP addresses and ports, making them efficient for high-throughput applications. In contrast, L7 load balancers function at the application layer, enabling more advanced routing decisions based on the content of requests, such as HTTP headers and URLs.

An App GW instance can be equivalent to a single hardware load balancer. Each App GW instance is composed of M Ingress GW instances and N TLB nodes. Multiple VIPs can be hosted by an App GW instance. A request targeted to any VIP can ingress through one of the TLB nodes and then be forwarded to one of the Ingress GW nodes through an IP-in-IP tunnel before being routed to a service endpoint. The response is sent back directly from the Ingress GW node to the client. Incoming TLS connections to the VIP terminate on one of the Ingress GW nodes. A new connection to the service back-end pod is established from the Ingress GW node, which is a persistent connection. The connection terminates on the envoy proxy instance in the POD, which is also a mesh component.

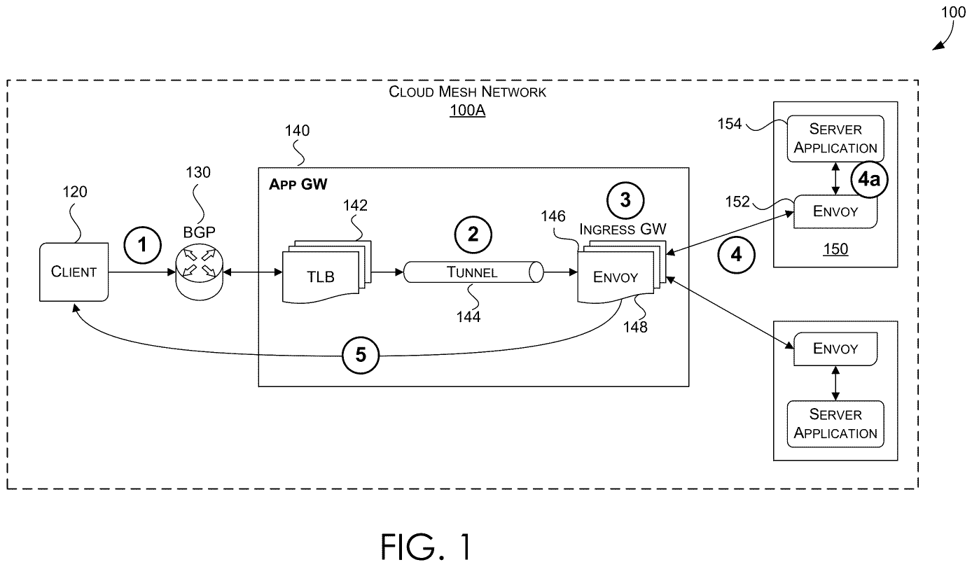

With reference to FIG. 1, FIG. 1 illustrates a cloud computing system 100 with a cloud mesh network 100A architecture (e.g., Tess App GW architecture) designed to manage incoming requests efficiently while providing secure and reliable access to backend services. Central to this architecture is the concept of modular components that work in concert to facilitate seamless communication from clients to service endpoints. At the forefront of this architecture is the client 120, which represents the users or systems initiating requests for services. Client 120 operates with a Border Gateway Protocol component (e.g., BGP 130) used for routing traffic effectively between different networks. Client 120 is the source of requests aiming to access services hosted behind the App GW 140. Clients target specific Virtual IPs (VIPs) hosted by the App GW 140, marking the entry point associated with the cloud mesh network 110. When a request is made, it first encounters the App GW 140, which serves as the central hub for managing these incoming requests, distributes them to the appropriate services, and provides visibility and routing.

Each App GW instance comprises several Ingress GW 146 instances and Transport Layer Balancer (TLB) 142 nodes. Ingress GW 146 is a gateway node where incoming TLS connections terminate and are routed to backend service pods. The TLB nodes are operate to distribute incoming requests across the available Ingress GWs, ensuring a balanced load and preventing any single node from becoming overwhelmed. Requests targeted to a VIP ingress through one of these TLB nodes, which then forward the requests to the Ingress GW nodes through an IP-in-IP tunnel (e.g., tunnel 144). This tunneling mechanism provides a secure and efficient means of transporting data between components.

As requests reach the Ingress GW nodes, they encounter the TLS termination process, where incoming secure connections are decrypted. Here, a persistent connection is established to the backend service pods, specifically connecting to the App GW Envoy 148 to server envoy 152. Server envoy 152 can be envoy proxy instance that operates within the application pod, managing communications between the Ingress GW 146 and the backend service, represented by the server 150 and server application 154.

The server application 154 is where the core business logic resides. It processes requests and generates responses, which are then relayed back through the established channels. The response follows the same path in reverse: from the server application through the server envoy 152, back to the Ingress GW 146; but from the Ingress GW 146 directly to the client 120. While this architecture handles traffic and secures communications, it faces a critical challenge regarding visibility. Currently, metrics on request duration are captured at the Ingress GW 146 and the Envoy proxy 148, yet detailed insights into latency per hop and the specific paths taken by requests through the mesh remain elusive. This lack of visibility complicates the troubleshooting process, making it difficult for teams to identify hotspots or latency issues within the mesh.

Understanding how data packets travel through the cloud mesh network architecture 110 and the time they take at each step can be challenging. A cloud mesh network architecture faces a significant challenge due to the lack of visibility into the latency per hop and the path taken by requests. This issue complicates the process of diagnosing network performance problems, optimizing resource allocation, and ensuring reliable service delivery.

By way of illustration, when a request is made to a service VIP (Virtual IP address), it traverses multiple nodes within the network, including TLB nodes and Ingress GW nodes. However, without detailed insights into the time taken at each hop, it becomes difficult to identify where delays are occurring. This lack of granular data hampers the ability to pinpoint performance bottlenecks, making troubleshooting a complex and time-consuming task.

Moreover, the inability to track the exact path of requests through the mesh means that hot spots—areas experiencing higher than normal traffic or delays—cannot be easily identified and addressed. This can lead to performance degradation and affect the overall reliability of the network. For a network to be reliable, it must consistently deliver requests in a timely manner, and unexpected delays can undermine this reliability.

By way of example, a web application hosted on a Tess Cloud Mesh is accessed by a user. A request is sent from the user's browser to a service VIP managed by the Tess Cloud Mesh. This request traverses several components before reaching the service endpoint responsible for processing it. Initially, the request is directed to a TLB node, where load balancing is handled at the L4 level. From there, the request is forwarded through an IP-in-IP tunnel to one of the Ingress GW nodes. At the Ingress GW node, which functions as an L7 load balancer, the request is processed and sent to the appropriate service endpoint. A connection to the service backend pod is established, and the envoy proxy within the pod takes over the handling of the request. Once at the service endpoint, the request is processed, and a response is generated before being sent back through the same path to reach the user's browser. Within this scenario, several potential points of latency exist: the time taken for the request to travel from the TLB node to the Ingress GW node; the processing time at the Ingress GW node; the duration required for the request to reach the service endpoint and for the response to be generated; and the time needed for the response to travel back through the Ingress GW node and TLB node to the user's browser.

Without visibility into the latency at each of these hops, pinpointing the source of delays becomes challenging. For example, if a slow response time is experienced by the user, potential causes could include: extended processing time at the TLB node; delays occurring within the IP-in-IP tunnel between the TLB and Ingress GW nodes; bottlenecks present at the Ingress GW node; slow processing at the service endpoint.

The lack of visibility into the latency per hop and the path taken by requests through the Tess Cloud Mesh presents significant challenges in diagnosing issues, optimizing performance, and ensuring reliability. The proposed solution seeks to address these challenges by providing detailed insights into the network's performance, thereby improving its overall efficiency and reliability. In particular, the proposed solution involves deploying packet interceptors (e.g., eBPF Extended Berkeley Packet Filter programs) and custom Envoy filters to measure and record the duration of packet processing at various points within the network. By capturing detailed metrics on the path and latency of requests, this system aims to make the path from the client to the service endpoint visible. This visibility will enhance the ability to diagnose issues, optimize performance, and ensure the network operates reliably.

By implementing the proposed solution, which includes deploying packet interceptors (e.g., Extended Berkeley Packet Filter “eBPF” programs) and custom Envoy filters, detailed metrics on the path and latency of requests can be captured. For instance, an eBPF program attached to the TLB node can measure the time taken for packet processing and forwarding. Similarly, an additional eBPF program at the Ingress GW node can track the time spent on request processing and forwarding to the service endpoint.

With these metrics in place, if slow response times are reported by a user, network administrators can swiftly identify whether the delay occurs at the TLB node, the Ingress Gw node, or the service endpoint. This enhanced visibility facilitates more efficient troubleshooting and optimization, ensuring reliable and efficient network operations.

By way of illustration, in a complex network, data packets can take various paths based on routing protocols, congestion, and configurations. For instance, consider a request made from a user in New York to a service hosted in a data center in California. The packet may pass through several nodes (like routers and gateways) before reaching its destination. If there's no clear visibility into how long each hop takes, it becomes difficult to identify where delays are occurring. For example, if the first hop from the user's device to the local router takes 5 ms, but the next hop to the regional data center takes 50 ms due to congestion, without tracking this, the network team might assume the issue is at the service endpoint rather than recognizing the delay is happening earlier in the route.

To optimize performance, it's necessary to see the exact path a request takes from start to finish. This means knowing which nodes it passes through and how long it spends at each. Using a system that tracks requests, a network administrator can see that a request went from the client to the Ingress GW, then to a load balancer, and finally to a TLB node before reaching the service endpoint. If the load balancer introduces a latency of 40 ms, this information allows the team to focus on optimizing that specific component.

Detailed metrics are important for diagnosing issues and enhancing network performance. These metrics should not only show average latencies but also identify patterns and anomalies. If metrics reveal that during peak hours, latency at the TLB node consistently spikes to 100 ms, the network team can investigate further. They might discover that this node is overloaded and needs scaling up, or that there's a configuration issue affecting performance.

### Example Systems and Resources

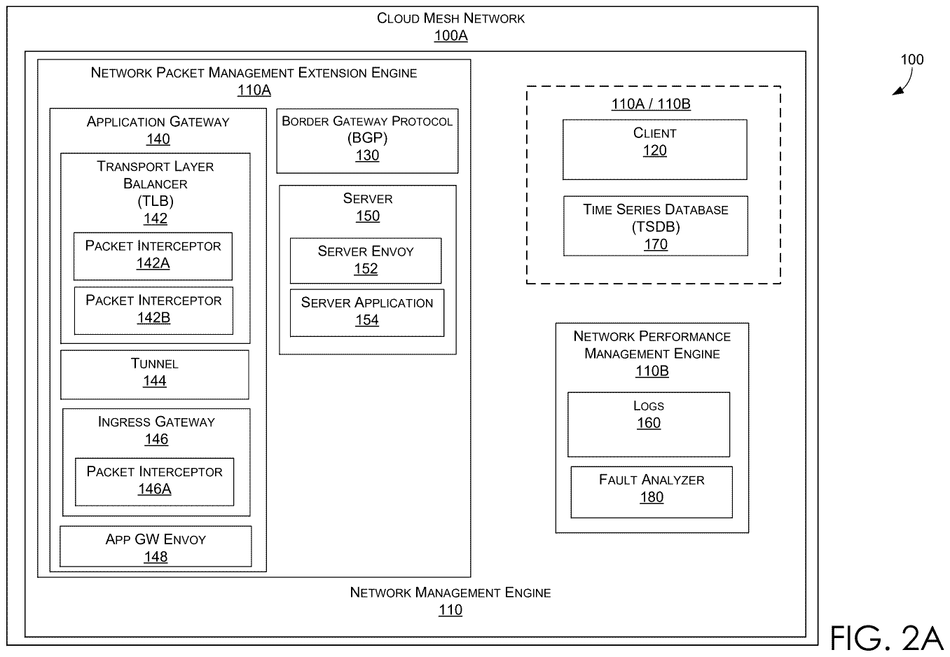

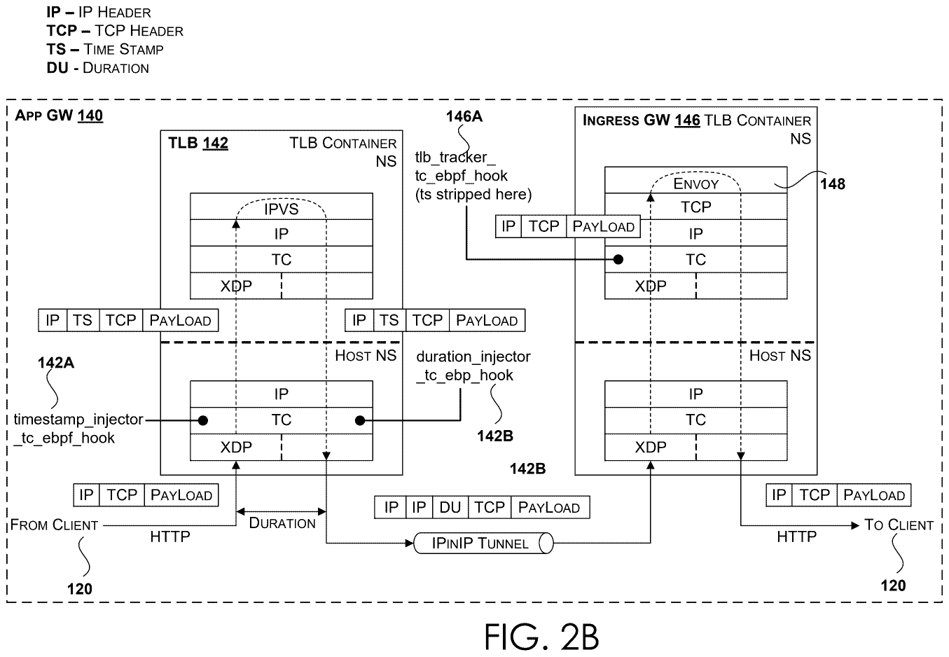

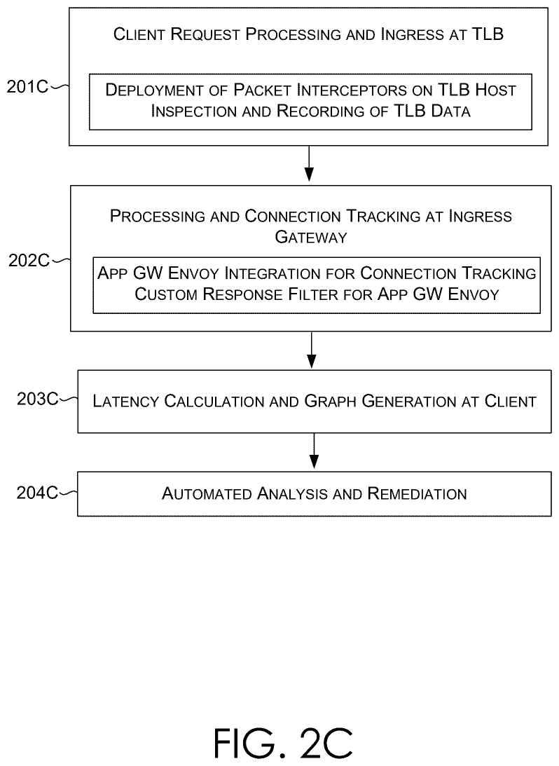

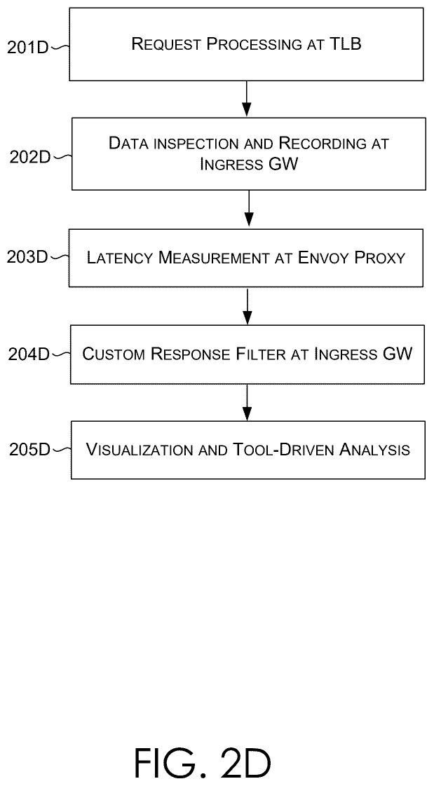

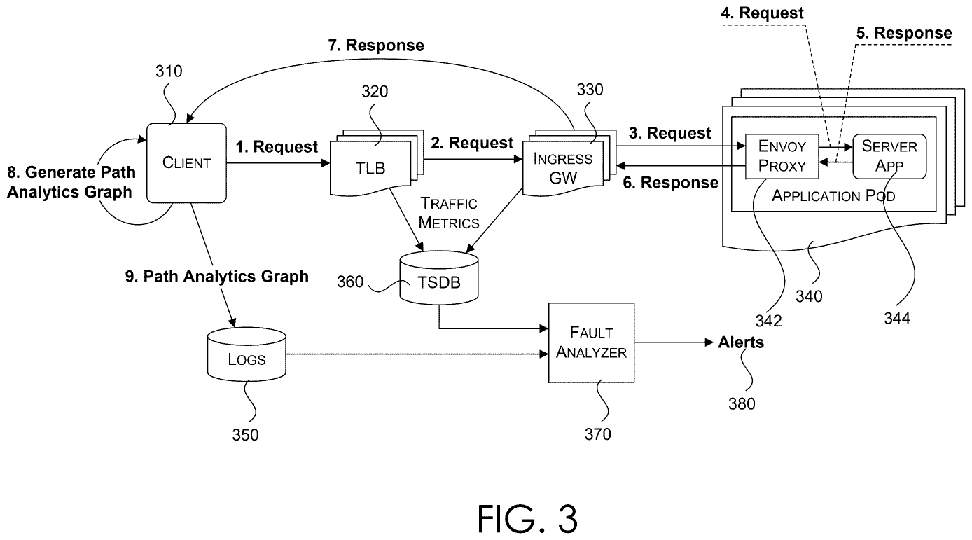

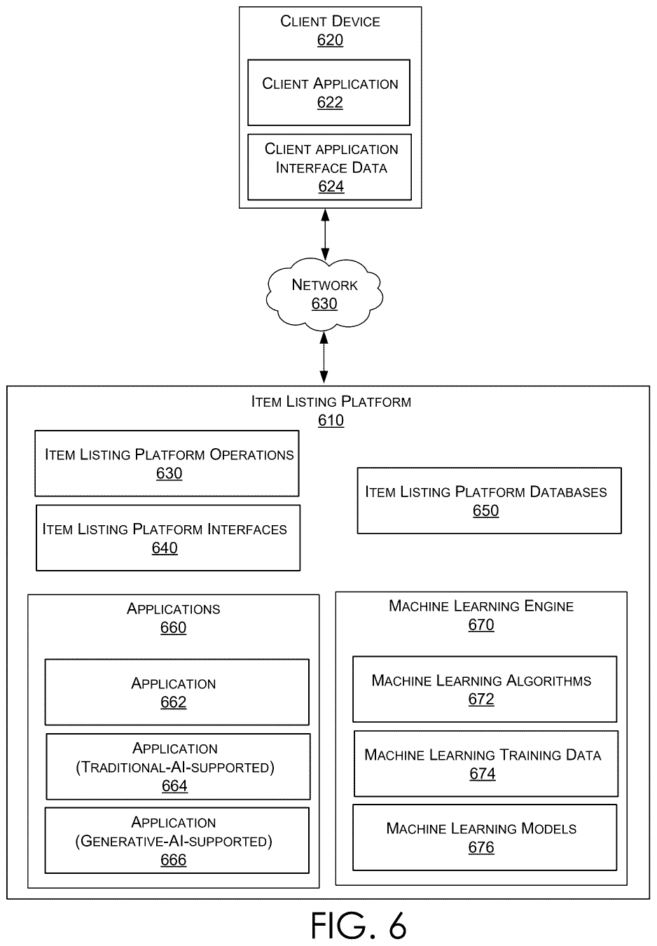

Aspects of the technical solution can be described by way of examples and with reference to FIGS. 2A, 2B, 2C and 3. FIG. 2A illustrates cloud computing system 100 that includes cloud mesh network 110, network packet management extension engine 110A and network performance management engine 110B; client 120, Border Gateway Protocol (BGP) 130, Application Gateway (App GW) 140, Transport Layer Balancer (TLB) 142, packet interceptor 142A, packet interceptor 142B, tunnel 144, Ingress Gateway (Ingress GW) 146, packet interceptor 146A, Application Gateway Envoy (App GW envoy) 148, server 150, server envoy 152, server application 154, logs 160, Time Series Database (TSDB) 170 and fault analyzer 180. The cloud computing system 100 corresponds to the cloud computing system associated with item listing system 600 described below with reference to FIG. 6.

Network packet management extension engine 110A and network performance management engine 110B are collectively referred to as network management engine 110. Network management engine 110 is an end-to-end system that oversees, monitors, and optimizes the full lifecycle of network traffic, from the initial client request to the final data response. By capturing, analyzing, and managing network packets, it ensures seamless data flow and tracks key performance metrics to identify and resolve latency or congestion issues.

Network packet management extension engine 110A is a specialized engine designed for calculating and analyzing packet latency at various stages of a network path. Network packet management extension engine 110A enhances network packet handling by capturing detailed information at crucial points in the flow. For instance, during client request processing and Ingress at the TLB and data inspection and recording at Ingress Gateway (GW), it enables the measurement of packet transit times, captures metadata, and supports connection tracking by recording latency within the network. Network packet management extension engine 110A powers custom processing and data recording that provides deep insight into latency dynamics across the network infrastructure.

Network performance management engine 110B is a specialized engine that identifies and manages deviations from expected network behavior, particularly in areas where latency may occur. By monitoring network traffic, analyzing latency patterns, and visualizing data, network packet management extension engine 110A detects performance issues and supports automated remediation through AI. Key features include latency calculation and graph generation at the client, which visualizes latency data through path analytics graphs, and automate analysis and remediation, which leverages tools to correlate latency with system resources and reroute traffic if necessary. Network performance management engine 110B, through tools like the fault analyzer 180, provides a holistic view of network performance and aids in preemptive issue resolution.

The network management engine 110 leverages a layered approach to network management, monitoring, and fault detection, each component playing a part in ensuring efficient data flow, capturing metrics, and analyzing performance. Below is a detailed breakdown of each component, including its role, data handled, interfaces, and primary operations.

Client 120 client initiates network requests to access services or applications. Client 120 can represent either an end user or an automated system making requests to the backend. Client 120 communicates outgoing network requests, which include headers, source/destination IPs, and payloads. Client 120 sends requests to network entry points (such as App GW 140). Client 120 initiates connection requests and awaits responses, while optionally capturing response headers and latency data for analysis.

BGP 130 (Border Gateway Protocol) determines optimal paths for packets across networks. In this architecture, it ensures that packets follow efficient, reliable routes to reach backend services. BGP 130 may include routing tables associated with network path metrics. BGP 130 connects with routers and network gateways, sharing routing information to improve path selection. BGP 130 updates routing paths dynamically based on network conditions, minimizes latency, and reroutes traffic as necessary to avoid congestion.

App GW 140 provides an entry point for client traffic. App GW 140 filters, manages, and directs traffic to internal services, such as the Transport Layer Balancer (TLB) 142. App GW 140 accesses and processes incoming requests from clients, including IP headers and payloads. App GW 140 interfaces with clients, TLB, and other internal services. App GW 140 further validates incoming requests, applies security policies, and forwards traffic to the TLB for load balancing.

TLB 142 is responsible for distributing incoming traffic across multiple service instances. This ensures balanced workload distribution and minimizes latency. TLB 142 processes incoming packets with headers, timestamps, and metadata. TLB 142 connects to Ingress Gateway (GW) 146 through tunnel 144. TLB 142 distributes requests to backend services based on load, availability, and other performance factors. TLB 142 hosts packet interceptor 142A and packet interceptor 142B to timestamp packets and monitor latency.

Packet interceptor 142A and packet interceptor 142B are at the TLB level provide in-kernel monitoring and data manipulation, allowing high-performance packet inspection and latency tracking. Packet interceptor tracks network packet headers, timestamps, and processing metrics. Packet interceptors attach to the TLB's ingress and egress points to monitor packet flow. Packet interceptor 142A timestamps incoming packets at ingress, and Packet interceptor 142B records exit times at egress. Together, they compute processing duration within the TLB.

Tunnel 144 securely transports packets between TLB 142 and Ingress GW 146. This encapsulated path prevents interference and maintains data integrity. Tunnel 144 processes encrypted packet payloads with headers and connects TLB to Ingress GW. Tunnel 144 provides a secure pathway for network traffic, maintaining isolation and data protection as packets move through the infrastructure.

Ingress Gateway (Ingress GW) 146 manages incoming traffic from the TLB 142, forwarding it to the appropriate service instances. Ingress GW 146 processes network packets with encapsulated metadata and communicates with App Gw Envoy 148 and TLB 142. Ingress GW 146 directs packets to specific application instances or proxies, attaching packet interceptor 146A to further monitor processing times and extract relevant data for latency analysis.

Packet interceptor 146A operates within the Ingress GW 146 to log timestamps and gather metadata as packets flow through. Packet interceptor 146A processes packet metadata, such as timestamps and source IP and monitors ingress and egress traffic within the Ingress GW 146. Packet interceptor 146A tracks packet traversal time from entry to exit at the Ingress GW 146, calculating latency and capturing relevant metrics for analysis.

Application Gateway Envoy (App GW Envoy) 148 is an Envoy proxy at the application gateway level that attaches metadata to packets, creating tracking headers for end-to-end latency monitoring. App Gw Envoy 148 processes packets annotated with tracking headers, latency metrics and communicates with Ingress GW, adding data to response packets that are passed from backend servers. App Gw Envoy 148 inserts tracking headers for each packet, providing hop-by-hop visibility into network latency and duration at each node.

Packets are associated with packet latency data that refers to the collected metrics and contextual details that quantify how long it takes a packet to move through specific network elements and, by extension, the overall network path. Beyond their kernel-level representation, these metrics can be surfaced at the application layer through HTTP headers inserted by intermediary proxies like Envoy. In other words, the same latency data—initially captured in a low-level data structure—is transformed into human-readable form within HTTP headers attached to response packets, thereby offering clients and downstream systems end-to-end visibility into per-hop delays and network performance bottlenecks.

For instance, the measured TLB duration, along with other timing metrics recorded at different hops, may be injected into HTTP headers before a response packet is sent back to the client. These headers, which can include fields like X-CORP-MESH-TLB-DURATION or similar identifiers, allow the receiving end to gain a clear, hop-by-hop understanding of the network delays encountered. As a result, latency data collected at the map level is translated into meaningful application-layer insights, enabling clients or observability tools to analyze and respond to network performance issues with greater precision

Packet latency data can be stored in a kernel-level data structure—specifically, a map—that associates a particular network flow's identifying information with key latency measurements recorded at the transport layer balancer (TLB). This data structure operates using a key-value paradigm. The key is constructed from the inner packet's source IP address and source port, uniquely identifying a given flow or connection attempt. The corresponding value includes the tunnel source IP and the measured TLB duration. The tunnel source IP identifies the specific TLB host that forwarded the packet, while the TLB duration quantifies the time the packet spent transiting the TLB node. By pairing these elements, the packet latency data not only records how long a packet lingered within a critical network component (the TLB) but also correlates this timing with a specific source endpoint and the TLB node through which it passed.

Packet latency data provides granular insight into per-hop delays and network behavior. It enables downstream processing components—such as an Envoy proxy or other monitoring tools—to retrieve, analyze, and annotate network flows with precise latency information. This allows operators and automated systems to isolate slow network segments, identify performance bottlenecks, and gain a detailed, hop-level understanding of the packet's journey through the cloud mesh.

Server 150 processes the client request, executing backend functions based on the received data. Server 150 processes incoming requests, including packet payloads and then connects with server Envoy 152 and Server Application 154. Server 150 provides backend services and data processing, responding to the client's request. Server Envoy 152 is an Envoy proxy at the server level. Server Application 154 is at the application layer, where client requests are processed according to business logic. Server Application 154 processes requests and response payloads communicates with the server 150 and server Envoy 154. Server application 154 executes core operations, generating responses that are sent back to the client 120. In route to the client, App GW Envoy 148 adds final tracking headers and timestamps to outgoing packets, providing complete visibility into latency and network path.

Logs 160 store detailed records of network events, metrics, and errors for later analysis. Logs 160 data includes timestamped logs capturing network activity, packet metadata, latency measurements. Logs 160 is accessible by Fault Analyzer 180. Logs 350 collects and organizes logs, providing a historical record of network performance and events. Time Series Database (TSDB) 160 stores time-stamped network data (e.g., traffic metrics from TLB 142 and Ingress GW 146) providing a structured dataset for latency and performance analysis. TSDB 360 data includes time series metrics, including latency, packet flow, and error rates. TSDB 360 aggregates metrics over time, supporting efficient retrieval for analysis, visualization, and historical comparisons. TSDB 170 operates with fault analyzer 180 to support generating alerts.

Fault analyzer 180 identifies performance issues by analyzing logs and metrics from the TSDB. Fault analyzer 180 processes time series data, log entries, fault metrics. In particular, fault analyzer 180 receives data from logs 160 and TSDB 170, and generates alerts based on detecting anomalies in network performance, issuing alerts if latency exceeds thresholds, enabling proactive management and troubleshooting.

This layered setup creates a framework for monitoring, analyzing, and optimizing network performance across a complex service infrastructure. From initial client requests to backend processing and performance analytics, each component plays a distinct role in ensuring reliable, high-performance network operations.

With reference to FIG. 2B, FIG. 2B illustrates a schematic 100B associated with providing network management engine in accordance with embodiments described herein. The process is initiated by client 120, which sends a network request destined for a specific service. This request traverses multiple layers and components, each carefully configured to optimize network performance and enhance visibility into the network's state. Each component in this architecture is integrated to enable data collection, latency analysis, and fault detection, using advanced mechanisms like BGP 130 and packet interceptors across different nodes.

Upon initiation, the client 120 request is directed to the App GW 140, which processes incoming traffic and balances it across the system's available servers. App GW 140 serves as an entry point for directing packets to appropriate backend services. Next, the request is forwarded to the TLB 142, which is responsible for distributing network traffic across multiple application instances to ensure optimal load balancing and low latency. For instance, when an HTTP packet enters the App GW 140, it first travels through the IP layer and is encapsulated in TCP (Transmission Control Protocol) for reliable delivery. The packet then passes through the XDP (eBPF eXpress Data Path), where it may undergo filtering or redirection for high-performance packet processing. From there, it is handed off to the Traffic Control (TC) system, which can enforce policies like bandwidth shaping or prioritization before being forwarded to the IPVS (IP Virtual Server) load balancer, which distributes the traffic to appropriate backend servers based on the configured load balancing method. Throughout this path, the payload (the application data) remains intact, and the overall processing time is minimized by the efficient handling of each network layer.

Within the TLB 142, eBPF programs 142A and 142B are deployed to monitor packet flow at both ingress and egress points. These eBPF programs are kernel-based technologies designed for packet filtering and monitoring in high-speed environments. eBPF 142A attaches to the ingress traffic path to mark each incoming packet with a timestamp, creating a baseline for measuring latency. eBPF 142B then attaches to the egress traffic path, measuring the time packets spend within the TLB node, which provides an initial measure of network latency.

From the TLB, traffic flows through a Tunnel 144 that links the TLB to the Ingress Gateway (Ingress GW) 146. This tunnel is designed to secure data transport between the TLB and the ingress gateway, ensuring that traffic remains isolated and optimized as it travels through the network infrastructure. A packet traveling through a tunnel to the Ingress GW 146 is encapsulated within multiple layers. It starts with an IP header followed by another IP header (for tunneling), and then the duration (DU), the TCP segment with its corresponding payload (application data). This entire packet is forwarded through the tunnel, where the outer IP header handles routing to the ingress gateway, which will decapsulate the tunnel and pass the packet to its destination for further.

Upon reaching Ingress GW 146, another eBPF program, eBPF 146A, is attached to track packets as they enter and exit the gateway. This eBPF program is configured to monitor key metrics such as packet arrival time, source IP, and transport duration, adding another layer of latency monitoring within the gateway node. A packet traveling through the Ingress Gateway 146 begins by being processed at the XDP (eBPF eXpress Data Path) level, where it is filtered or redirected for high-performance handling before it reaches the kernel's networking stack. From there, it passes through Traffic Control (TC), which applies policies such as traffic shaping or prioritization to manage the flow and ensure Quality of Service (QoS). The packet is then routed at the IP layer, where its destination is determined, and if necessary, it is encapsulated for tunneling or forwarding to the appropriate backend.

Finally, Envoy (i.e., App Gateway Envoy 148), as a service proxy, may handle the packet at the application layer, performing tasks like load balancing, routing, and applying any additional network policies before it reaches its intended service or application. Envoy operates to record the source IP address, source port, and destination IP address associated with each new TCP connection. To accomplish this, an Envoy network filter will be introduced and executed whenever a new TCP connection is established.

During initialization, the network filter will query the kernel to retrieve the TLB IP address and TLB duration associated with the {source IP, source port} key. Once this information is obtained, it will be stored in memory for reference during response processing. After the lookup, the corresponding kernel entry will be immediately deleted to maintain a clean state.

To prevent stale data from accumulating, a garbage collector within Envoy will periodically remove outdated map entries. For example, it could run every two minutes and remove entries older than 90 seconds. This approach ensures efficient memory usage and guards against potential memory leaks.

Turning to FIG. 2A, upon arrival at server Envoy 152, the Envoy proxy inspects the packet before reaching the server application 154. Here, the actual server application 154 processes the client's request, handling operations specific to the requested service. After processing, the server application's response is routed back through server Envoy 162 and retraces its steps through App Gateway Envoy 148 and Ingress GW 146 to the client 120.

The client extracts and calculates the network latency data. The client can update a log database with path analytics graph to support generating alert. A path analytics graph is a visual representation that maps out the distinct paths that packets take across a network and provides detailed insights into the latency and performance metrics at each hop. This type of graph is especially valuable in complex network environments, where packets can travel through multiple routers, switches, and gateways, each potentially influencing overall latency based on congestion, routing decisions, or Quality of Service (QoS) configurations.

In constructing a path analytics graph, data is gathered at key network nodes, including entry points, intermediate routers, gateways, and the destination. Each node in the graph represents a point where metrics such as latency, packet drop rate, and jitter are measured. As packets progress along their routes, these nodes help pinpoint the precise locations of delays or performance degradations. For instance, if packets consistently experience high latency at a specific router, the path analytics graph will highlight this, enabling network administrators to focus on resolving the issue at that node rather than broader network segments.

The path analytics graph also incorporates data on dynamic routing changes and varying traffic patterns, illustrating how packets may traverse different routes under different conditions. This real-time tracking allows for accurate latency calculations across each path, giving administrators a clear view of where congestion or anomalies are impacting network performance. In cases where tools rely on aggregated data, the path analytics graph adds granularity by capturing detailed metrics at each network hop, making it possible to detect and address subtle anomalies that might otherwise go unnoticed.

In network management, a path analytics graph provides visibility into the operational health of the network, correlating traffic flow with node-level performance data. By identifying potential problem areas at each stage of packet transit, it supports more efficient troubleshooting, faster resolution times, and optimized routing paths to improve overall network reliability and responsiveness.

Turning to node-level traffic metrics, a node-level traffic metric refers to a set of specific measurements and performance indicators collected at each network node, which together provide insight into data flow, resource utilization, and latency behavior at a granular level. These metrics offer a localized perspective on the health, efficiency, and operational status of nodes within a broader, distributed network environment. By gathering these metrics at the node level, the system enables precise, real-time visibility into traffic patterns and resource constraints that influence end-to-end network performance.

In the network management engine, each node (such as the Transport Layer Balancer, Ingress Gateway, or Application Gateway) generates, and tracks metrics associated with its own activity, resource use, and traffic handling. For instance, packet drops at a node's NIC or within its kernel highlight where data packets might be failing to transmit successfully, offering clues to potential congestion or capacity issues. CPU and memory utilization metrics provide a view into processing demand and availability, helping manage resource allocation effectively. These metrics directly support the solution's goal of achieving real-time latency analysis and enabling timely adjustments for optimized packet routing and processing.

Moreover, metrics like round-trip time (RTT) histograms, congestion-limited connection counts, and open TCP/UDP port counts contribute to detailed visibility into connection health and stability. By correlating these node-level traffic metrics with data stored in components like the Time Series Database, the solution can perform advanced analysis to detect anomalies and pinpoint deviations from expected performance, enhancing the accuracy and responsiveness of network management. Ultimately, node-level traffic metrics serve as the foundational data that powers latency monitoring, fault detection, and automated network adjustments across the cloud mesh network, supporting this solution's focus on precise, path-specific traffic control and fault resolution.

By way of illustration, node-level traffic metrics provide insights into the health and performance of each network node, focusing on factors such as resource utilization, connection stability, and data flow efficiency. Each metric is essential in diagnosing network issues and optimizing traffic management, especially in complex systems where latency and resource constraints can impact overall performance.

Packet drops at the Network Interface Card (NIC) and within the kernel reveal potential bottlenecks or disruptions in data transmission. For example, if a node shows a high packet drop rate at the NIC, it may indicate issues with buffer capacity or an overloaded link, necessitating a closer look at traffic routing or hardware capacity. Within the kernel, packet drops could stem from processing limits, where packets are discarded before they are even forwarded, impacting the reliability of data transmission at a fundamental level.

The count of CPU cores exceeding a predefined utilization percentage (e.g., 75% utilization) within a one-second window is another vital metric. This measure allows for real-time insight into processing demand across the node, highlighting when specific tasks or traffic spikes are overloading resources. For instance, during peak periods, if multiple cores consistently exceed 75% usage, the node may need load balancing or further resource provisioning to avoid performance degradation.

Congestion-limited connections refer to connections that cannot proceed at their full capacity due to network congestion. Tracking the number of these connections can reveal when and where data traffic is encountering bandwidth constraints, providing a foundation for adjusting QoS settings or rerouting traffic to less congested paths.

A histogram of round-trip times (RTT) helps identify latency patterns and anomalies. For example, a normal distribution in RTT may indicate stable performance, but spikes or shifts in the histogram suggest fluctuating delays—potentially pointing to issues with routing paths or transient congestion. Monitoring RTT histograms enables quick identification of latency changes, which is invaluable for maintaining seamless, low-latency connections.

Metrics for the number of connections with receive memory (RMEM) and write memory (WMEM) exceeding provisioned thresholds help identify situations where data buffering exceeds what the node's memory can sustain. Connections frequently surpassing RMEM or WMEM thresholds could be a sign of inadequate buffer settings or unusually high data rates, requiring optimization to maintain data integrity and prevent connection slowdowns.

Packet and bit rates measure the volume of data passing through the node over time, allowing administrators to track overall throughput and identify unusual spikes or drops in data flow. For example, if a node experiences a sudden drop-in packet rate, it may indicate a routing issue, packet filtering, or an application failure upstream, prompting immediate investigation.

The count of open TCP and UDP ports on the node indicates which services are active and accessible. This information is essential for maintaining network security and efficiency, as unmonitored open ports can expose the system to unauthorized access or increased load from external sources.

Node memory utilization provides a view into available and consumed memory, helping gauge whether memory resources are sufficient for current tasks. High memory utilization without sufficient management can lead to paging, ultimately slowing down data processing and packet handling.

Memory bandwidth utilization shows how much memory access capacity is being used, particularly relevant in data-intensive applications. If memory bandwidth is fully utilized, it may slow down access to critical data, leading to bottlenecks even if CPU and network resources are underutilized.

Lastly, tracking the percentage of CPU consumed by eBPF on the host highlights the processing demand of eBPF programs that manage packet handling and monitoring. For instance, if eBPF programs are using a significant share of CPU, it could limit resources for other processes on the node, indicating a need to optimize the efficiency of these monitoring functions.

These node-level traffic metrics collectively provide a comprehensive view of network health and performance at each node. Through consistent monitoring and analysis of these metrics, network administrators gain the tools to diagnose, adjust, and optimize node performance across varied traffic conditions and operational demands.

By way of illustration, with reference to bandwidth utilization, determining that bandwidth utilization has been met involves correlating increases in packet latency with rising traffic loads, as observed through multiple packet interceptors deployed across the network. As more data flows through the network, traffic patterns become denser, and packets begin to contend for the same resources, such as queues and transmission buffers. The packet interceptors record this growing competition as incremental increases in latency. For example, when traffic volume surpasses a certain threshold, packets may start queuing at the transport layer balancer or experience slower forwarding rates in the ingress gateway. These conditions are reflected in the timestamped packet data: previously negligible latency grows noticeably, both at individual nodes and cumulatively along a packet's multi-hop path. By continuously comparing current latency readings against established performance baselines, the system can detect subtle shifts that indicate congestion. Once the interceptors report sustained latency elevations across multiple points in the network—especially those known to be capacity-limiting segments—the system infers that available bandwidth has effectively been consumed.

Throughout the network management process, logs 160 are continuously updated with information on packet flow, latency measurements, and processing durations at each network node. These logs serve as a persistent repository of network activity, which is invaluable for troubleshooting and retrospective analysis. To manage and analyze the large volume of real-time data, TSDB 170 is utilized. This specialized database is optimized for time-stamped data, capturing metrics from each hop in the request path, including timestamps, hop-specific latency, and error rates. The TSDB aggregates this information to provide an end-to-end view of network performance.

Finally, a fault analyzer 180 processes data from both the logs and the TSDB 170 to detect deviations from normal performance benchmarks. If latency spikes or packet losses are detected beyond acceptable thresholds, the Fault Analyzer generates alerts, prompting network administrators to investigate and, if necessary, remediate the issue. By analyzing trends and identifying anomalies, the Fault Analyzer acts as a proactive layer of monitoring and control, safeguarding the network's reliability and efficiency.

In this way, network management engine 110 integrates advanced components and technologies—to deliver a comprehensive solution for network management, performance monitoring, and fault detection. The architecture enables precise latency measurements at each network node, provides end-to-end visibility, and allows for rapid response to network irregularities, ensuring optimal performance and reliability for client-server interactions.

With reference to FIG. 2C, FIG. 2C illustrates a flow diagram associated with a network packet management extension engine that enhances visibility into the mesh by tracking request paths and hop-level latencies, enabling prompt troubleshooting and potentially automated recovery for performance optimization. The network packet management extension engine provides a trackable path for request handling, monitoring latency at each node and enabling automated, real-time responses to optimize network performance and maintain service availability. Path identification and TLB duration measurement can be illustrated with reference to the following steps:

At step 201C: Client Request Processing and Ingress at TLB: the client request process begins when a client—or a synthetic traffic generator—initiates a request aimed at a Virtual IP (VIP) associated with a specific service. This VIP is a unique IP that serves as a single point of entry, directing the request through the mesh of network components that facilitate routing, monitoring, and latency tracking. The first component to receive the request is the Transport Layer Balancer (TLB), which handles routing at the network's edge to direct traffic to appropriate services.

Deployment of eBPF Programs on TLB Host: To enhance tracking and optimize latency, several eBPF programs are deployed on the TLB host. eBPF allows small programs to run in the kernel to monitor and analyze packet data, minimizing performance overhead by executing only when specific traffic conditions are met.

eBPF 1 is attached to the Traffic Control (TC) hook at ingress (entry point of the TLB), this program's function is to timestamp incoming SYN packets for IPs associated with the TLB's VIPs. This timestamp helps track the exact entry time of packets as they reach the TLB, providing a reference point for latency analysis. To optimize performance, this eBPF 1 uses a per-CPU sampling approach, ensuring only one SYN packet per CPU core per second is processed to reduce the load on the system.

eBPF 2 is also attached to the TC hook, but at the egress (exit point of the TLB), this eBPF 2 measures the duration from packet ingress to egress within the TLB, which includes any time spent creating a network tunnel. The time spent within the TLB is calculated and written as a TLB duration in the inner IP option of the packet, giving a precise measure of TLB processing latency.

Inspection and Recording of TLB Data eBPF 3 inspects tunneled packets and records relevant metadata—such as the source IP, source port, TLB IP address, and TLB duration. This data is essential for understanding where latency may be introduced in packet processing. This program attaches to the TC in the ingress Gateway (GW) pod, logging metadata for each packet that will be referenced in subsequent connection analysis.

At step 202C—Processing and Connection Tracking at Ingress Gateway (GW): When the request reaches the ingress GW, it is processed by App GW Envoy, a high-performance proxy service that routes and monitors network traffic. To track and report latency, a network filter in Envoy collects essential metadata.

App GW Envoy Integration for Connection Tracking: A network filter in APP GW Envoy captures the source IP, source port, and TLB information (e.g., TLB processing duration, TLB host IP). This information, initially logged by eBPF programs at the TLB, is now accessible for each connection, allowing Envoy to assess request handling times as they move through each layer of the network. A garbage collector function clears out old entries from memory every two minutes to prevent data overflow, which ensures that only relevant, recent data is stored.

Custom Response Filter for App GW Envoy—App Gw Envoy also adds specific tracking headers to each HTTP response to capture detailed processing information. This response filter is deployed within the Ingress GW pod, recording request latency at several points and attaching metadata for each layer the packet traverses:
X-CORP-MESH-PROXY-DURATION: Represents the processing time within the Envoy proxy.
X-CORP-MESH-PROXY-POD: Identifies the proxy pod by IP or FQDN, allowing tracking at the pod level.

Additional Headers:
X-CORP-MESH-INGRSS-GW-DURATION: Shows the overall processing time within the ingress GW.
X-CORP-MESH-INGRSS-GW-POD: Identifies the ingress GW pod.
X-CORP-MESH-TLB-HOST: Captures the source IP from the TLB, as retrieved from local memory.
X-CORP-MESH-TLB-DURATION: Reflects the time taken by the TLB to process the request.

At step 202C—Latency Calculation and Graph Generation at Client: Upon receiving the HTTP response, the client extracts tracking headers that were added by App GW Envoy in the Ingress GW. These headers provide a full account of the latency across various network points:
The client captures headers such as X-CORP-MESH-PROXY-DURATION and X-CORP-MESH-TLB-DURATION, each representing latency at key nodes (e.g., TLB, ingress GW, Envoy proxy).

The client logs this data as a JSON object, allowing for a structured representation of the network path and latency per node:
{
   “nodes”: [
      {“id”: 1, “label”: “client”},
      {“id”: 2, “label”: “tlb”},
      {“id”: 3, “label”: “ingress-gw”},
      {“id”: 4, “label”: “envoy-proxy”},
      {“id”: 5, “label”: “svc-endpoint”}
   ],
   “edges”: [
      {“id”: 1, “label”: “client_to_tlb”,
“latency_in_millis”: <CtoTlb(t)>},
   {“id”: 2, “label”: “tlb_to_ingrss_gw”,
“latency_in_millis”: <TlbToIgw(t)>},
   {“id”: 3, “label”: “ingrss_gw_to_envoy_proxy”,
“latency_in_millis”: <IgwToProxy(t)>},
   {“id”: 4, “label”: “envoy_proxy_to_svc_endpoint”,
“latency_in_millis”: <ProxyToSvc(t)>}
   ]

At step 204C—Automated Analysis and Remediation: Tools (e.g., fault analyzer) analyzes the JSON latency data, correlating it with kernel metrics to identify any bottlenecks. If network congestion, resource exhaustion, or unusual latency spikes are detected, the tools can initiate adjustments through a VIP scheduler, which reroutes traffic and allocates resources dynamically to improve network performance and ensure reliability. It is contemplated that to operate efficiently within the network, root access for App GW Envoy can be enabled to support BPF capabilities. If security protocols restrict root access, an alternative solution involves implementing a remote RPC (Remote Procedure Call) proxy; however, this may add significant latency due to additional routing overhead.

To measure network latency without compromising packet flow, the duration is included within an IP option using the Timestamp IP option, a feature specified in IP standards for experimental purposes. This option, largely unused in typical network configurations, was chosen for its compatibility with latency measurement. By attaching it only to TCP SYN packets, any additional performance overhead is minimized; this approach avoids the costly adjustments required for packet headroom, which can slow down high-rate packet processing.

The timestamp is applied only to traffic directed at Virtual IPs (VIPs) moving between the Transport Layer Balancer (TLB) and the Ingress Gateway (GW). This selective approach ensures that the IP option remains hidden from other network devices along the path, securing it from unnecessary exposure while also keeping it optimized. Even though the inclusion of a timestamp brings some lookup costs within the kernel, these costs are minimized with the use of a per-CPU hash map, which allows lock-free lookups. This structure reduces bottlenecks, enabling latency tracking with high efficiency.

Within this framework, the design measures packet latency from the host to the guest namespace, through the IPVS load balancer, and down to the egress point in the Linux kernel. The timestamp IP option is then removed at the lowest level of the Linux networking stack in the Ingress GW to avoid its appearance in responses to the client. Without this removal step, the IP option would be visible across every device in the packet's network path, potentially adding latency, as some devices process IP options for IPv4 in a slower path. The timestamp also could increase packet size, risking fragmentation and further delays. To prevent this, the timestamp is stripped specifically at the Traffic Control (TC) hook in the guest network namespace, an efficient choice that avoids the heavy performance cost of attaching the eXpress Data Path (XDP) to the virtual Ethernet (veth) interface in the guest namespace.

Further performance optimization is achieved through per-CPU sampling, which reduces the frequency of timestamp updates between the TLB and Ingress GW by a factor of 16. This implementation significantly lightens the processing load on the system without compromising the accuracy of latency tracking. Through this combination of targeted timestamp use, efficient data handling, and strategic processing points, the design achieves detailed latency measurement while maintaining high network performance.

With reference to FIG. 2D, FIG. 2D illustrates a flow diagram associated with an example implementation of network management illustration how hop-level visibility is achieved using eBPF, Envoy filters, and header metadata to measure latency per hop, enabling detailed analysis and automated issue resolution. In operation, a request to access a VIP service is initiated by a client (or synthetic traffic generator). The request is routed through various components in the Tess Cloud Mesh, where hop-by-hop latency is measured, and metadata is collected to aid in troubleshooting and visibility.

At 201D—Request Processing at TLB: A client request is directed to a Virtual IP (VIP) address associated with a service. The request first reaches one of the TLB (Transport Layer Balancer) nodes. Multiple eBPF (extended Berkeley Packet Filter) programs are deployed on the TLB host to monitor the request. These programs may be activated only for traffic flowing from TLB to the ingress GW (Gateway) node, thus minimizing overhead.

First eBPF Program: At the TLB, an eBPF program attached to a TC (Traffic Control) hook at ingress is activated. A timestamp IP option is added to incoming SYN packets directed to TLB VIPs. This timestamp records the precise time the packet entered the TLB host. To reduce processing costs, timestamping is limited to one SYN packet per CPU core per second.

Second eBPF Program: The second eBPF program, also attached to the TC hook, measures the time the packet spends from entry to exit within the TLB host kernel, including tunnel creation time. The calculated TLB duration is then written into the timestamp field in the packet's inner IP option, thus providing TLB-level latency measurement.

At step 202D—Data Inspection and Recording at Ingress GW: After exiting the TLB node, the request is forwarded to an ingress GW node. At the ingress GW, a third eBPF program inspects the packet for data tracking. This program stores the packet's metadata, including the source IP, source port, TLB IP address, and TLB processing duration. A BPF (Berkeley Packet Filter) map is used for this data. The key consists of the inner packet's source IP and port, while the value includes the TLB duration and TLB IP. A network filter within the Envoy proxy retrieves the TLB metadata, storing it in memory to be referenced for additional latency metrics in response processing.

At step 203D—Latency Measurement at Envoy Proxy: The request is processed by the App Gw Envoy proxy in the service's application pod, where further latency information is measured. App Gw Envoy adds an HTTP header (X-CORP-MESH-PROXY-DURATION) to capture the time the endpoint service takes to process the request. Another HTTP header (X-CORP-MESH-PROXY-POD) is added to denote the App Gw Envoy proxy's IP or fully qualified domain name (FQDN) for traceability.

At step 204D. Custom Response Filter at Ingress GW: At the ingress GW, an App GW Envoy response filter records the request duration. The filter collects and adds the following HTTP headers to the response, using the TLB metadata stored in memory:
X-CORP-MESH-INGRSS-GW-DURATION: Total duration at ingress GW.
X-CORP-MESH-INGRSS-GW-POD: IP or FQDN of the ingress GW pod.
X-CORP-MESH-TLB-HOST: Source IP from the TLB.
X-CORP-MESH-TLB-DURATION: Processing duration at the TLB.

The collected data is stored in a BPF map, with older entries periodically aged out to prevent memory leaks.

At step 205D: Client-Side Response Processing: Upon receiving the response, the client extracts and logs relevant headers to calculate per-hop latency:
X-CORP-MESH-PROXY-DURATION: Time spent by the service endpoint.
X-CORP-MESH-INGRSS-GW-DURATION: Time from ingress GW to the service.
X-CORP-MESH-INGRSS-GW-POD, X-CORP-MESH-PROXY-POD, X-CORP-MESH-TLB-HOST, and X-CORP-MESH-TLB-DURATION for tracing purposes.

Per-hop latency is computed by analyzing these headers, which reveal each hop's latency and any delays along the path.

At step 206D: Visualization and Tool-Driven Analysis

The recorded metrics are aggregated, for example, into a JSON document:
{
   “nodes”: [
      {“id”: 1, “label”: “client”},
      {“id”: 2, “label”: “tlb”},
      {“id”: 3, “label”: “ingress-gw”},
      {“id”: 4, “label”: “envoy-proxy”},
      {“id”: 5, “label”: “svc-endpoint”}
   ],
   “edges”: [
      {“id”: 1, “label”: “client_to_tlb”,
“latency_in_millis”: <CtoTlb(t)>},
   {“id”: 2, “label”: “tlb_to_ingrss_gw”,
“latency_in_millis”: <TlbToIgw(t)>},
   {“id”: 3, “label”: “ingrss_gw_to_envoy_proxy”,
“latency_in_millis”: <IgwToProxy(t)>},
   {“id”: 4, “label”: “envoy_proxy_to_svc_endpoint”,
“latency_in_millis”: <ProxyToSvc(t)>}
   ]
}

This JSON document can be parsed by an AI tool, which joins it with kernel-level metrics to identify bottlenecks or resource constraints. The tool (e.g., an AI tool) can trigger auto-remediation actions via the VIP scheduler when resource exhaustion or latency spikes are detected in the mesh, ensuring high availability and optimized performance.

With reference to FIG. 3, FIG. 3 illustrates an end-to-end implementation of the network management engine that offers several key capabilities that enhance network performance and visibility. One of its primary features is end-to-end latency tracking, which adds timestamp options to IP headers, allowing for precise measurement of each segment in a packet's path. This capability ensures that every hop can be accurately monitored for latency. Another important function is optimized sampling and filtering. By employing per-CPU sampling, the network management engine effectively reduces the performance impact associated with high-rate packet flows, ensuring that network efficiency is maintained even under heavy traffic conditions.

Additionally, custom response filtering and analytics are facilitated through Envoy network filters at each hop. These filters enrich packet headers with latency data, enabling hop-by-hop latency analysis, particularly useful for applications. The network management engine continuously logs metrics to time series database and utilizes a fault analyzer to identify and alert network issues in near real-time, allowing for swift intervention when problems arise.

In operation, client 310, sends a request (request 1) to TLB 320. The network management engine engages, marking each packet with an IP option timestamp upon arrival at the TLB 320. This timestamp acts as a foundational latency metric that will follow the packet through each step of the path, enabling an accurate view of time intervals between network nodes. The timestamp may be applied only to SYN packets destined for VIPs, which minimizes performance overhead.

Once the request (request 2) reaches Ingress GW 330, additional latency data is captured. Here, the network management engine applies an eBPF (Extended Berkeley Packet Filter) program at the egress to measure latency and packet traversal times across Ingress GW 330's kernel. The Ingress GW 330 also includes a custom Envoy network filter, which captures relevant metadata such as the TLB processing duration, TLB host IP, and client source IP. To manage data effectively and prevent memory overload, the Ingress GW 330 implements a per-CPU sampling technique, ensuring that only a controlled rate of SYN packets per core per second are processed, minimizing processing overhead. Ingress GW 330, utilizing an App GW Envoy (not shown) adds tracking headers to the packet, capturing hop-specific latency metrics that will be visible to client 310 upon receipt.

At Application POD 340, the packet reaches (request 3) the Server Envoy Proxy 342, where the Network Management Engine enables the custom response filter. This filter is configured to include key latency metrics—such as X-CORP-MESH-TLB-DURATION and X-CORP-MESH-INGRSS-GW-DURATION—in the headers of the outgoing response. These headers allow for precise tracking of each packet's path from the TLB 320, through Ingress GW 340, and back. The server Envoy Proxy 340 then forwards (request 4) the packet to server app 344, where it is processed, and the response (response 5) is returned to server Envoy proxy 342 for the reverse path. In the return process, the server Envoy Proxy 342 sends the response (response 6) back through Application POD 340 to Ingress GW 330 and then (response 7) client 310.

On receipt at client 310, the enriched response headers provide the data necessary to calculate hop-by-hop latency. Using these data points, the client generates a detailed analytics path graph that maps each network hop, illustrating latencies between client 310, TLB 320, Ingress GW 330, Application POD 340, server Envoy proxy 342, and server app 344. This path graph is logged in logs 350 for historical analysis.

Throughout each interaction, TLB 320 and Ingress GW 330 continuously send traffic metrics to the Time Series Database (TSDB 360), where the Network Management Engine's metrics on packet traversal rates, per-hop latency, and overall network performance are stored. This TSDB ensures accurate time-stamped records that allow for long-term trend analysis.

The fault analyzer 370 operates as part of the network management engine's proactive monitoring component. It receives data streams from both logs 350 and TSDB 360, examining them for signs of latency deviation, packet loss, or other indicators of network degradation. When anomalies are detected, the fault analyzer 370 generates alerts 380, enabling rapid troubleshooting and adjustments to routing paths or load balancing configurations.

Aspects of the technical solution can be described by way of examples and with reference to FIGS. 2A, 2B, 2C, 2D, and 3, FIG. 2A is a block diagram of an exemplary technical solution environment, based on example environments described with reference to FIGS. 6, 7 and 8 for use in implementing embodiments of the technical solution are shown. Generally, the technical solution environment includes a technical solution system suitable for providing the example cloud computing system 100 in which methods of the present disclosure may be employed. In particular, FIG. 2A shows a high-level architecture of the cloud computing system 100 in accordance with implementations of the present disclosure. Among other engines, managers, generators, selectors, or components not shown (collectively referred to herein as “components”), the cloud computing system 100 of FIG. 2 corresponds to FIG. 1.

### Example Methods

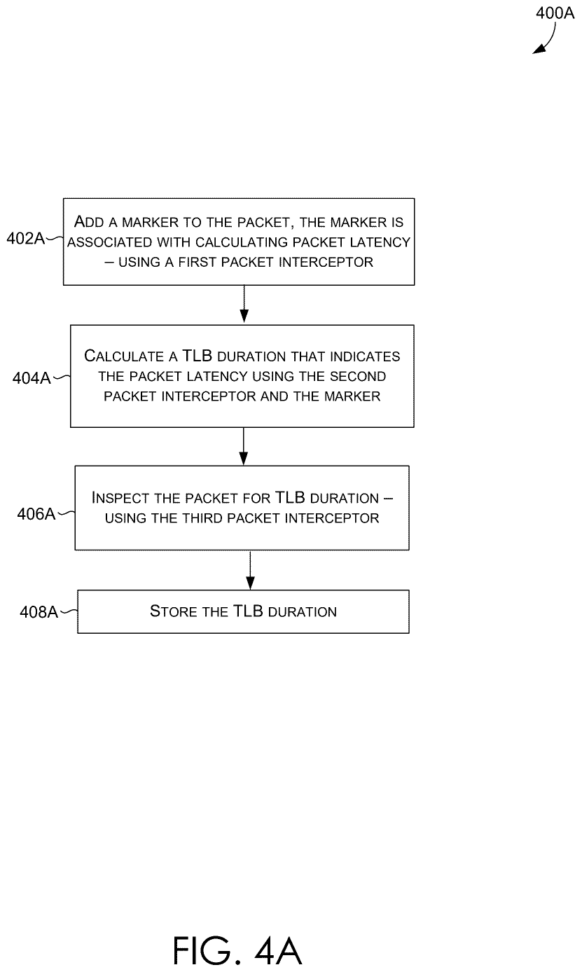

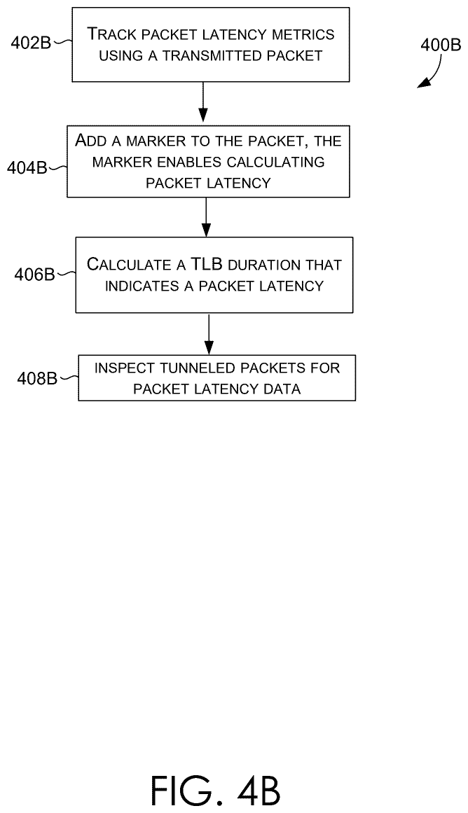

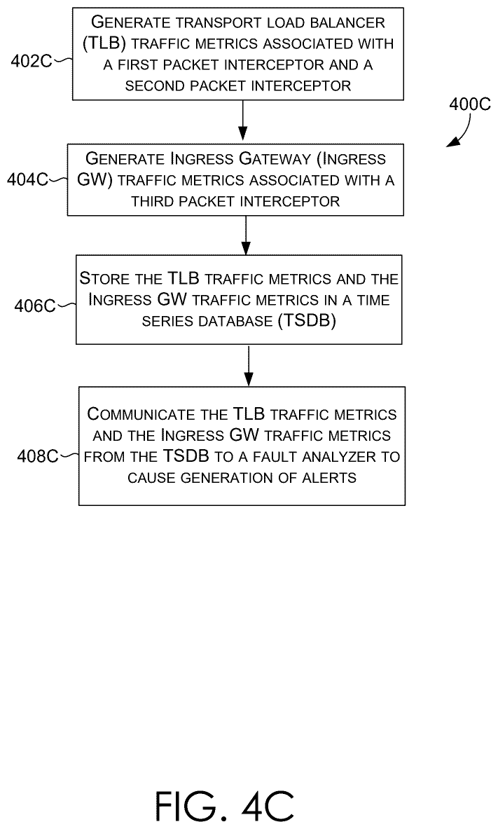

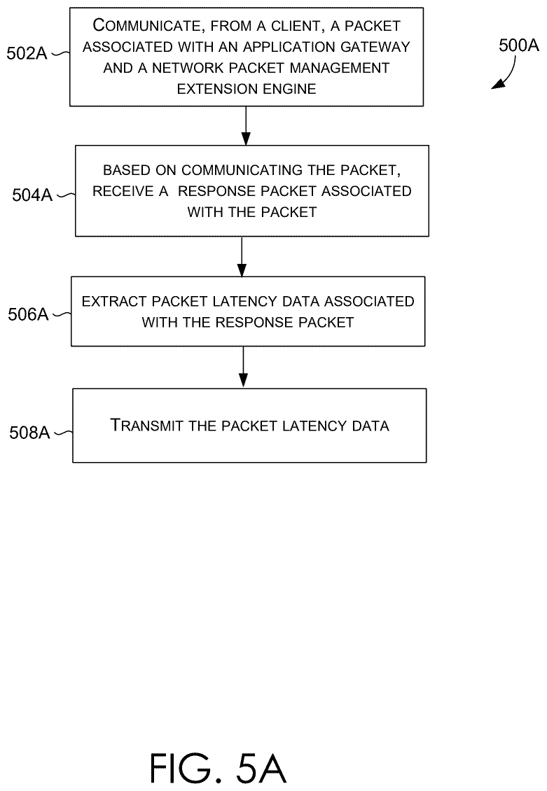

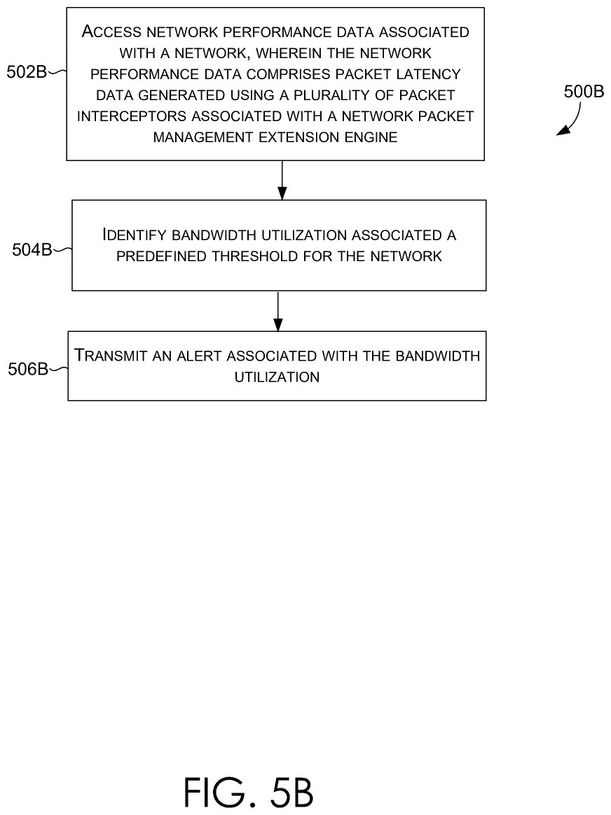

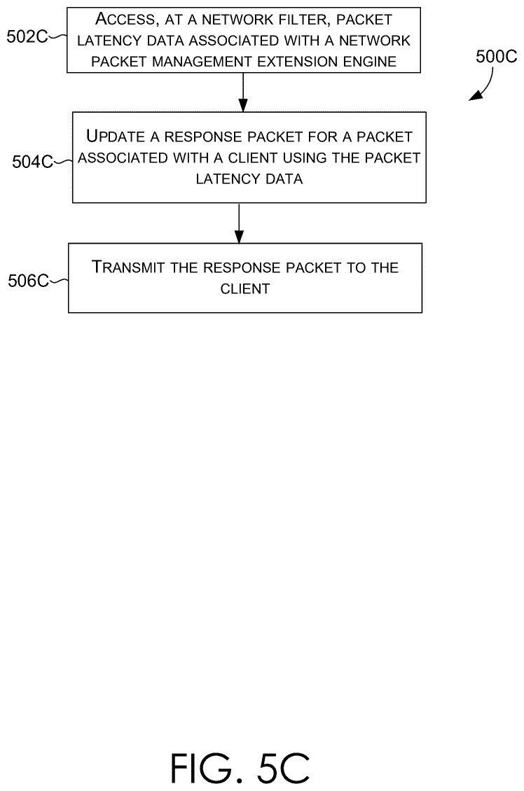

With reference to FIGS. 4A, 4B, 4C, 5A, 5B, and 5C flow diagrams that illustrate methods for providing a network management using a network management engine. The methods may be performed using the cloud computing system described herein. In embodiments, one or more computer-storage media having computer-executable or computer-useable instructions embodied thereon that, when executed, by one or more processors can cause the one or more processors to perform the methods (e.g., computer implemented method) in the cloud computing system (e.g., computerized system or computer system).

Turning to FIG. 4A, a flow diagram is provided that illustrates a method 400A for providing network management using a network management engine. At block 402A, a first packet interceptor adds a marker to the packet, the marker enables calculating packet latency. At block 404A, a second packet interceptor uses the marker to calculate a TLB duration that indicates the packet latency. At block 406A, a third packet interceptor inspects the packet the TLB duration. At block 408A, the network packet management extension engine stores the TLB duration.

Turning to FIG. 4B, a flow diagram is provided that illustrates a method 400B for providing network management using a network management engine. At block 402B, the network packet management extension engine tracks packet latency metrics using a transmitted packet; at block 404B add a marker to the packet, the marker enables calculating packet latency; at block 406B, calculates a TLB duration that indicates a packet latency associated with the TLB; and at block 408B, inspects tunneled packets for packet latency data.

Turning to FIG. 4C, a flow diagram is provided that illustrates a method 400C for providing network management using a network management engine. At block 402C, the network packet management extension engine generates transport load balancer (TLB) traffic metrics associated with a first packet interceptor and a second packet interceptor; at block 404C generates Ingress Gateway (Ingress GW) traffic metrics associated with a third packet interceptor; at block 406C stores the TLB traffic metrics and the Ingress GW traffic metrics in a time series database (TSDB); at block 408C transmit the TLB traffic metrics and the Ingress GW traffic metrics from the TSDB to a fault analyzer to cause generation of alerts.

Turning to FIG. 5A, a flow diagram is provided that illustrates a method 500A for providing network management using a network management engine. At block 502A, a client communicates a packet associated with an application gateway and a network packet management extension engine; at block 504A, the client, based on communicating the packet, receives a response packet associated with the packet; at block 506A, the client extracts packet latency data associated with the response packet; and at block 508A transmits the packet latency data.

Turning to FIG. 5B, a flow diagram is provided that illustrates a method 500B for providing network management using a network management engine. At block 502B, a fault analyzer accesses network performance data associated with a network, the network performance data comprises packet latency data generated using a plurality of packet interceptors associated with a network packet management extension engine; at block 504B; identifies bandwidth utilization associated a predefined threshold for the network; and at block 506B transmits s an alert associated with the bandwidth utilization.

Turning to FIG. 5C, a flow diagram is provided that illustrates a method 500C for providing network management using a network management engine. At block 502C, a network filter accesses packet latency data associated with a network packet management extension engine; at block 504C, updates a response packet for a packet associated with a client using the packet latency data; and at 506C, transmits the response packet to the client.

### Network Packet Management Extension Engine

The network packet management extension engine presented in this solution addresses the complex challenge of calculating and quantifying packet latency in real-time across diverse network topologies. Unlike conventional systems, this engine is designed to capture precise packet-level latency metrics by employing a series of packet interceptors distributed strategically across the network. These interceptors are positioned at critical junctions, namely, within the Transport Layer Balancer (TLB) and Ingress Gateway (Ingress GW), enabling packet data to be marked, inspected, and processed in a way that reveals granular insights into latency for each packet as it traverses the network.

Upon entering the network, packets first encounter a packet interceptor positioned at the traffic control hook of the TLB. At this point, the first packet interceptor adds a timestamp marker to each packet. This marker serves as a critical reference for calculating latency, capturing the packet's arrival time at the TLB host. By embedding this incoming timestamp, the engine establishes an initial data point for latency calculation, setting the foundation for precise tracking as the packet moves through the network.

As the packet progresses, it reaches a second packet interceptor positioned at the egress network interface of the TLB's traffic control hook. This second interceptor is tasked with calculating the TLB duration, a measure of latency associated specifically with the TLB's internal processing time. The TLB duration is derived by computing the difference between the packet's incoming timestamp (recorded by the first interceptor) and the current time when the packet reaches the second interceptor. This calculated TLB duration replaces the original timestamp in the packet's data. The inclusion of this duration allows the system to quantify latency incurred during TLB processing accurately, capturing any delays that may have resulted from load balancing, routing, or other TLB functions.

The packet then proceeds to a third packet interceptor located at the ingress gateway, where the engine inspects the packet to extract latency data, including the TLB duration. At this point, the packet's latency data is meticulously analyzed and cataloged. The extracted latency information, including the inner packet source IP, port tunnel source IP, and the TLB duration, is stored in a map structure. This data structure is organized with a key-value pair, where the key represents the unique combination of the inner packet source IP and port, while the value stores the tunnel source IP and TLB duration. By structuring the data this way, the engine achieves an efficient organization for retrieving latency metrics, facilitating both rapid analysis and minimal storage overhead.

A network filter (or network traffic filter) oversees the storage and management of packet latency data within the map. This filter operates to update the latency information associated with each packet as needed, ensuring that response packets sent back to clients carry accurate, up-to-date latency metrics. Through this updating mechanism, the filter enables the engine to reflect the latest network conditions and packet traversal times, allowing for a responsive and adaptive latency-tracking system.

To support the synchronization packet processing critical during connection establishment, the engine confines latency-tracking operations to synchronization packets. This selective approach minimizes unnecessary processing overhead while retaining high precision in latency calculation for new connections. By focusing on synchronization packets, the engine optimizes resource use, enhancing overall network performance without compromising latency visibility.

The engine's integration with the tunnel between the TLB and ingress gateway further amplifies its efficacy in tracking latency. As packets move through this tunnel, the marker timestamp offers a means to calculate tunnel-associated latency, capturing the total transmission time of the packet across this pathway. Additionally, the tunnel structure accommodates the unique latency data of each packet, preventing the loss of latency metrics even in high-throughput environments.

Each packet's latency data is preserved and processed in the network's time-series database, making it accessible for in-depth analysis and fault detection. By maintaining a continuous record of latency information, the time-series database allows for long-term trend analysis and historical performance monitoring. Furthermore, this data is fed into a fault analyzer, which leverages latency trends and discrepancies to detect potential network faults. Through real-time latency tracking and historical data analysis, the fault analyzer can identify deviations from expected network behavior, issuing alerts for network administrators to address possible issues proactively.

This implementation of the network packet management extension engine provides a robust, scalable solution to track and quantify packet latency accurately. By strategically placing packet interceptors to timestamp, calculate, and store latency data, the engine achieves a high level of visibility into packet flow, enabling real-time insights into network performance and latency characteristics across complex topologies. The network filter, time-series database, and fault analyzer components ensure that latency data is not only tracked but also preserved and analyzed to preemptively identify network issues, representing a substantial advancement in network latency monitoring and management.

### Network Performance Management Engine

The network performance management engine described in this technical solution provides an advanced, highly responsive framework for identifying and addressing deviations in network behavior, including packet latency across complex topologies. It enables both active clients and synthetic traffic generators to generate packets that reveal granular latency metrics, empowering network operators to respond dynamically to shifting network conditions and to detect anomalies across node-level metrics.

At the core of the network performance management engine, a series of strategically placed packet interceptors, forming part of a network packet management extension engine, operate within the network to capture packet latency metrics at specific intervals. The first packet interceptor, located at the traffic control hook of a Transport Layer Balancer (TLB), marks each incoming packet with a timestamp. This timestamp, added as a placeholder within the packet, captures the exact moment a packet enters the TLB, forming the basis for calculating packet-specific latency metrics. As the packet progresses, a second packet interceptor calculates the TLB duration by comparing the incoming timestamp with the current time, measuring the latency incurred during packet processing within the TLB. This calculated TLB duration is then embedded within the packet, allowing for accurate latency tracking and ensuring consistency across different paths and traffic flows. A third packet interceptor, positioned at the ingress gateway of the application gateway, inspects the packet for any additional latency data before forwarding it to its destination, thereby ensuring latency metrics remain comprehensive and up to date.

The network performance management engine's network filter facilitates the storage and management of latency data through a map structure, where latency metrics are efficiently organized with unique keys derived from each packet's inner source IP, port, and associated TLB duration. This approach allows the network performance management engine to update and manage packet latency metrics accurately, supporting real-time response packet updates based on evolving network conditions. As each client packet traverses the network, the network filter updates the corresponding response packet with relevant latency data extracted from the map, providing a complete latency profile as it is returned to the client. This process enables continuous monitoring of network performance from a packet-level perspective, revealing granular latency information that is critical for real-time anomaly detection and resolution.

Additionally, the network performance management engine's management includes generating and updating a path analytics graph, a dynamic visual representation of packet latency data associated with response packets and their routes. This graph offers detailed insight into latency across different network segments, allowing network administrators to observe latency patterns, identify deviations from normal performance, and take preemptive action as needed. By leveraging these visual analytics, administrators can see not only the overall performance of the network but also pinpoint specific areas where latency exceeds acceptable thresholds. This graphical data is further supplemented by node-level traffic metrics that reflect bandwidth utilization across different network nodes. The network performance management engine uses this data to set predefined bandwidth thresholds; once these are exceeded, alerts are triggered to notify administrators of potential network congestion or performance degradation, allowing for rapid intervention.

In cases where packet latency data reveals suboptimal path performance, the network performance management engine dynamically selects alternate paths to optimize packet delivery. By using the latency data generated from packet interceptors, the network performance management engine identifies potential alternative routes that reduce latency and enhance network performance. This dynamic rerouting mechanism not only ensures optimal path selection but also helps prevent network congestion, improving the overall efficiency and responsiveness of the network in real time.

The network performance management engine is designed to adapt seamlessly to both active network environments and synthetic traffic conditions. By supporting synthetic traffic generators, the network performance management engine simulates various network patterns and conditions, testing the network's response to dynamic traffic flows and identifying latency issues before they impact live traffic. This allows administrators to assess network performance under diverse conditions, offering valuable insights into how the network infrastructure responds to variable loads and identifying potential latency bottlenecks that might otherwise go undetected.

This technical solution, through its integrated packet interceptors, traffic filters, and performance monitoring capabilities, provides a framework for real-time, packet-level network management. By capturing latency data at critical points within the network, dynamically updating response packets, and generating detailed path analytics, the engine facilitates comprehensive monitoring of packet flow, enabling proactive anomaly detection and efficient network optimization across dynamic and complex topologies.

### Technical Improvement

Embodiments of the present invention have been described with reference to several inventive features (e.g., operations, systems, engines, and components) associated with an item listing system. Inventive features described include operations, interfaces, data structures, and arrangements of computing resources associated with providing the functionality described herein relative with reference to a network management engine associated with a cloud computing system.

Embodiments of the present invention relate to the field of computing, and more particularly to an artificial intelligence system. The following described exemplary embodiments provide a system, method, and program product to, among other things, execute operations that provide network management. Therefore, the present embodiments improve the technical field of cloud mesh network technology providing more network management. For example, the network management engine enhances monitoring and performance management across complex network topologies. Packet latency can be calculated and quantified in real time, allowing deviations from expected network behavior to be identified with precision. The network management engine captures fine-grained traffic metrics, offering a detailed view of network performance at the packet level without relying solely on sampled data. By leveraging advanced telemetry and real-time analytics, it supports a proactive approach to performance monitoring, detecting subtle anomalies that traditional systems might overlook. Additionally, the network management engine enables correlation between node-level traffic metrics and observed network behavior, which helps improve troubleshooting accuracy and accelerates response to performance issues across dynamically routed network paths. Through these capabilities, network visibility is enhanced, allowing for more efficient resource utilization and optimized network operations.

Functionality of the embodiments of the present invention have further been described, by way of an implementation and anecdotal examples—to demonstrate that the operations for providing network management using a network management engine in a cloud computing system as a solution to a specific problem in cloud mesh network technology to improve computing operations in cloud computing systems.

### Additional Support for Detailed Description of the Invention

### Example Item Listing System Environment

Referring now to FIG. 6, FIG. 6 illustrates an example item listing system 600 computing environment in which implementations of the present disclosure may be employed. In particular, FIG. 6 shows a high-level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services—including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 630) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing system's functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 120 supports the process of building, training, and fine-tuning machine learning models. Machine learning training data 120 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including content generation, product image generation, personalized product recommendations, natural language chatbots, and content summarization. Traditional AI models encompass a wide range of algorithms and techniques and can be employed in various ways including recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

Item listing system 600 provides item listing system data that informs customer service interactions, and as such, can operate with a customer service management system to address any issues or questions that arise from those item listings. A customer service management system can be software solution designed to streamline and automate the handling of customer inquiries and support requests across various communication channels. The customer service management system centralizes customer interactions, allowing service teams to efficiently categorize, prioritize, and resolve issues, while tracking and managing each case through its lifecycle. With integrated tools such as ticketing systems, knowledge bases, and automation features like AI-driven chatbots, it enhances response times, reduces manual effort, and ensures consistent, high-quality customer service. The item listing system and customer service management system can be integrated to ensure seamless communication and efficient resolution of customer concerns.

### Example Distributed Computing System Environment

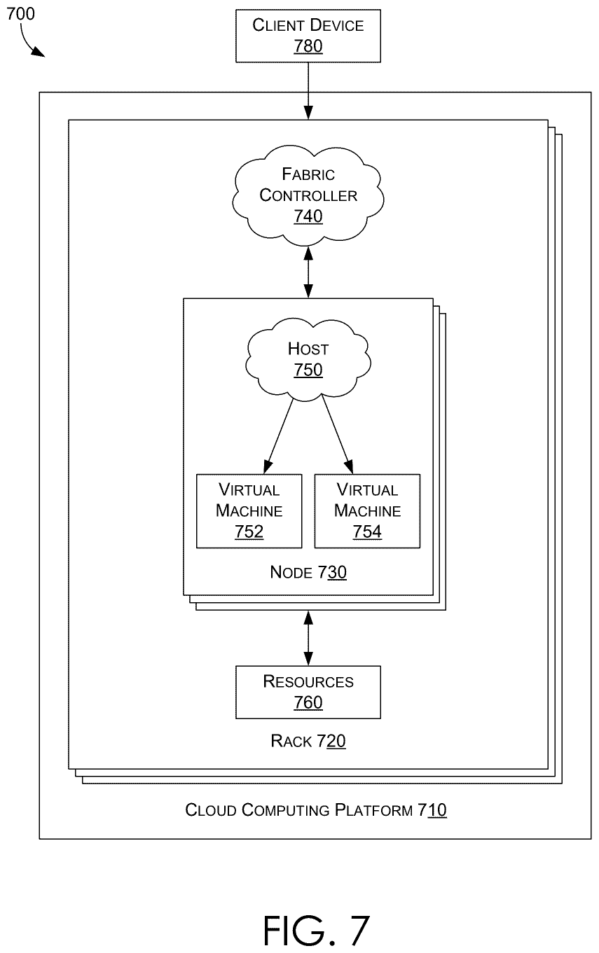

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

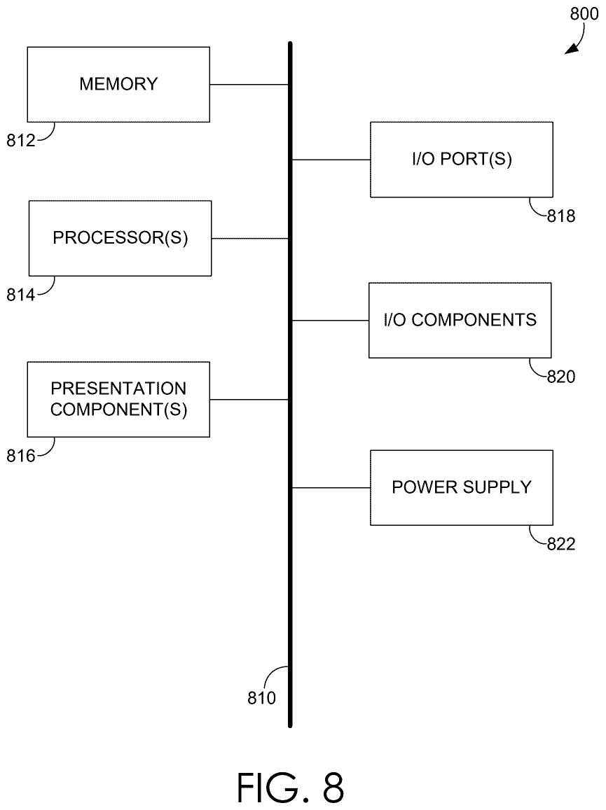

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however, the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
communicating, from a client, a packet associated with an application gateway and a network packet management extension engine, wherein the network packet management extension engine comprises a plurality of packet interceptors that support tracking packet latency metrics using transmitted packets via the application gateway;
based on communicating the packet, receiving a response packet associated with the packet, the packet is associated with packet latency metrics tracked using the plurality of packet interceptors;
extracting packet latency data associated with the response packet and the packet latency metrics; and
transmitting the packet latency data.

2. The system of claim 1, the operations further comprising using the packet latency data, generating a per hop latency associated with the packet.

3. The system of claim 1, the operations further comprising communicating the packet latency data to update a packet latency log associated with a path analytics graph, wherein the path analytics graph is a visual representation of patent latency data associated with response packets and their corresponding routes.

4. The system of claim 1, the operations further comprising dynamically selecting an alternate path for subsequent packets based on the packet latency data.

5. The system of claim 1, wherein a network filter updates the response packet based on the packet latency data.

6. The system of claim 1, wherein a network filter supports lookup operations and delete operations that are executable on a map data structure storing the packet latency data to support updating the response packet.

7. The system of claim 1, wherein the client is a synthetic traffic generator that simulates network traffic patterns and conditions for testing and evaluating a performance of the network.

8. One or more computer-storage media having computer-executable instructions embodied thereon that, when executed by a computing system having a processor and memory, cause the processor to perform operations, the operations comprising:
accessing network performance data associated with a network, wherein the network performance data comprises packet latency data generated using a plurality of packet interceptors;
determining bandwidth utilization has met a predefined threshold for the network, wherein determining the bandwidth utilization has been met is based on the packet latency data tracked using the plurality of packet interceptors in the network; and
transmitting an alert associated with the bandwidth utilization.

9. The media of claim 8, wherein the network performance data comprises a path analytics graph based on response packets from one or more clients, wherein the path analytics graph is a visual representation of patent latency data associated with the response packets and their corresponding routes.

10. The media of claim 8, wherein the network performance data comprises traffic metrics associated with a Transport Layer Balancer (TLB) and an ingress gateway.

11. The media of claim 8, wherein the network comprises an application gateway and a Transport Layer Balancer (TLB) operationally coupled to an ingress gateway via a tunnel.

12. The media of claim 8, wherein the plurality of packet interceptors include a first packet interceptor configured to add an incoming time to a timestamp option in incoming packets, wherein the first packet interceptor is operationally coupled to a traffic control hook of the TLB.

13. The media of claim 8, wherein the plurality of packet interceptors include a second packet interceptor configured to calculate a Transport Layer Balancer (TLB) duration that indicates a packet latency, wherein the second packet interceptor is operationally coupled to an egress network interface of a traffic control hook of the TLB.

14. The media of claim 8, wherein the plurality of packet interceptors include a third packet interceptor configured to inspect tunneled packets for packet latency data, wherein the third packet interceptor is operationally coupled to an ingress network interface of a traffic control hook of the ingress gateway.

15. The media of claim 8, wherein the alert is associated with a node-level traffic associated with the network.

16. The media of claim 8, wherein determining the bandwidth utilization has been met is based on correlating an increase in packet latency via the packet latency data to an increase in traffic loads in the network.

17. A computer-implemented method, the method comprising:
accessing, at a network filter, a response packet associated with packet latency data determined from a plurality of packet interceptors that support tracking packet latency metrics using transmitted packets;
using the packet latency data, updating the response packet associated with a client; and
transmitting the response packet to the client.

18. The computer-implemented method of claim 17, wherein the network filter supports lookup operations and delete operations that are executable on a map data structure storing the packet latency data to support generating the response packet.

19. The computer-implemented method of claim 17, wherein the packet latency data is stored in a map data structure associated with a key and a value, wherein the key is based on an inner packet source IP and a port, and the value is based on a tunnel source IP and the TLB duration.

20. The computer-implemented method of claim 17, wherein the network filter is operationally coupled to a server application and an ingress gateway of an application gateway comprising a Transport Layer Balancer (TLB) operationally coupled to an ingress gateway via a tunnel.
